(19) United States
(12) Patent Application Publication
(10) Pub. No.: US 2025/0163742 A1
(43) Pub. Date: May 22, 2025

(54) SLAT CONNECTION SYSTEM FOR ROLLER SHUTTER

(71) Applicants: Hyundai Motor Company, Seoul (KR); Kia Corporation, Seoul (KR); PHA Co., Ltd., Daegu (KR)

(72) Inventors: Yeon Soo Eo, Chuncheon-si (KR); Chan Joo Jeon, Gunpo-si (KR); Dong Young Kim, Hwaseong-si (KR)

(21) Appl. No.: 18/641,823

(22) Filed: Apr. 22, 2024

(30) Foreign Application Priority Data
Nov. 16, 2023 (KR) 10-2023-0159401

(51) Int. Cl. E05D 15/24; E05D 15/06

(52) U.S. Cl. CPC E05D 15/242; E05D 15/063

(57) ABSTRACT

An embodiment of a slat connection system for a roller shutter includes a plurality of slats pivotably hinged together, where each slat of the plurality of slats includes a slat body having a first edge and a second edge opposing each other, the inner hinge provided at the first edge, and an outer hinge provided at the second edge, where the inner hinge of a first slat of the plurality of slats is pivotably received in a hinge groove of an outer hinge of a second slat of the plurality of slats with a sealing member interposed between the first and second slats, and where the inner hinge and the sealing member are each positioned in parallel to a flat outer slat surface.

### CROSS-REFERENCE TO RELATED APPLICATIONS

This application claims the benefit of Korean Patent Application No. 10-2023-0159401, filed on Nov. 16, 2023, which application is hereby incorporated herein by reference in its entirety.

### TECHNICAL FIELD

The present disclosure relates to a slat connection system for a roller shutter.

### BACKGROUND

A roller shutter may be mounted in a door opening of a structure such as a cargo van, a trailer, a truck, or a garage. The roller shutter may be a type of door including a plurality of slats pivotably hinged together. The roller shutter may include a drive shaft allowing the plurality of slats to be wound or unwound, and a motor rotating the drive shaft. As the plurality of slats are wound around the drive shaft, the roller shutter may be opened. As the plurality of slats are unwound from the drive shaft, the plurality of slats may be aligned straightly and the roller shutter may be closed.

The plurality of slats may be continuously arranged through a plurality of hinge mechanisms, and each hinge mechanism may be configured to pivotably interconnect two adjacent slats. Each slat may include a slat body having a first edge and a second edge opposing each other, an inner hinge provided at the first edge of the slat body, and an outer hinge provided at the second edge of the slat body. The inner hinge and the outer hinge may protrude from an interior surface of the slat toward an interior space of the structure. The inner hinge of any one slat may be pivotably received in the outer hinge of another adjacent slat so that the two adjacent slats may be pivotably interconnected through the hinge mechanism. In addition, the hinge mechanism may include a sealing member interposed between the two slats, and the sealing member may be positioned to cover the inner hinge and the outer hinge. The sealing member, the inner hinge, and the outer hinge may be arranged in a direction perpendicular to a flat surface of the slat, and accordingly the thickness of the hinge mechanism protruding from the interior surface of the slat may be relatively increased.

According to the related art, because the hinge mechanism is relatively thick, the hinge mechanism of one slat may be stacked on another adjacent slat when the plurality of slats are wound around the drive shaft. Thus, the winding radius of the slats may be relatively increased, and a package of the roller shutter may become more complex.

The above information described in this background section is provided to assist in understanding the background of the present disclosure, and may include information that is not considered as the prior art that is already publicly known or in public use.

### SUMMARY

The present disclosure relates to a slat connection system for a roller shutter, and more particularly, to a slat connection system for a roller shutter designed to significantly reduce a thickness of a hinge mechanism protruding from the slats.

An embodiment of the present disclosure has been made to solve the above-mentioned problems occurring in the prior art while advantages achieved by the prior art can be maintained intact.

An embodiment of the present disclosure provides a slat connection system for a roller shutter that can be designed to significantly reduce a thickness of a hinge mechanism protruding from slats.

According to an embodiment of the present disclosure, a slat connection system for a roller shutter may include a plurality of slats pivotably hinged together. Each slat may include a slat body having a first edge and a second edge opposing each other, an inner hinge provided at the first edge, and an outer hinge provided at the second edge. An inner hinge of a slat may be pivotably received in a hinge groove of an outer hinge of another adjacent slat with a sealing member interposed between the two adjacent slats. The inner hinge and the sealing member may be positioned in parallel to a flat surface of the slat.

The slat may further include a sealing receiving portion provided at the first edge, the sealing receiving portion may have a groove, and the sealing member may include an insert fitted into the groove of the sealing receiving portion.

The inner hinge may be connected to the sealing receiving portion through a connection neck, and the connection neck may be parallel to the flat surface of the slat body.

The hinge groove may be open in a direction perpendicular to the flat surface of the slat body.

The outer hinge may include a first hinge guide and a second hinge guide protruding from an interior surface of the slat body. The hinge groove may be defined by the first hinge guide and the second hinge guide.

The outer hinge may protrude from the interior surface of the slat body by a first thickness, the sealing receiving portion may protrude from the interior surface of the slat body by a second thickness, and the first thickness of the outer hinge may be less than the second thickness of the sealing receiving portion.

An interior edge of the inner hinge may be closer to the interior surface of the slat body than an interior edge of the sealing receiving portion.

An interior edge of the first hinge guide and an interior edge of the second hinge guide may be closer to the interior surface of the slat body than an interior edge of the sealing receiving portion.

### BRIEF DESCRIPTION OF THE DRAWINGS

The above and other features and advantages of embodiments of the present disclosure can be more apparent from the following detailed description taken in conjunction with the accompanying drawings, in which:

FIG. 1 illustrates a perspective view of a state in which a roller shutter according to an example embodiment of the present disclosure is closed;

FIG. 2 illustrates a perspective view of a state in which a roller shutter according to an example embodiment of the present disclosure is opened;

FIG. 3 illustrates a perspective view of a slat connection system for a roller shutter according to an example embodiment of the present disclosure;

FIG. 4 illustrates a zoomed-in side view of a hinge mechanism of the slat connection system illustrated in FIG. 3;

FIG. 5 illustrates a portion of a slat connection system according to an example embodiment of the present disclosure;

FIG. 6 illustrates a state in which slats are vertically aligned in a slat connection system according to an example embodiment of the present disclosure;

FIG. 7 illustrates a state in which a slat is inclined with respect to another adjacent slat at an angle in a slat connection system according to an example embodiment of the present disclosure; and

FIG. 8 illustrates a state in which a hinge mechanism of a slat is stacked on another slat when a plurality of slats are wound around a drive shaft in a slat connection system according to an example embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. In addition, a detailed description of well-known techniques associated with the present disclosure can be omitted to avoid unnecessarily obscuring the gist of the present disclosure.

Terms such as “first”, “second”, “A”, “B”, “(a)”, and “(b)” may be used to describe elements in example embodiments of the present disclosure. Such terms can be merely used to distinguish one element from another element, and the intrinsic features, sequence or order, and the like, of the corresponding elements are not necessarily limited by such terms. Unless otherwise defined, terms used herein, including technical or scientific terms, can have the same meanings as those generally understood by those with ordinary knowledge in the field of art to which the present disclosure pertains. Such terms as those defined in a generally used dictionary can be interpreted as having meanings equal to or equivalent to the contextual meanings in the relevant field of art.

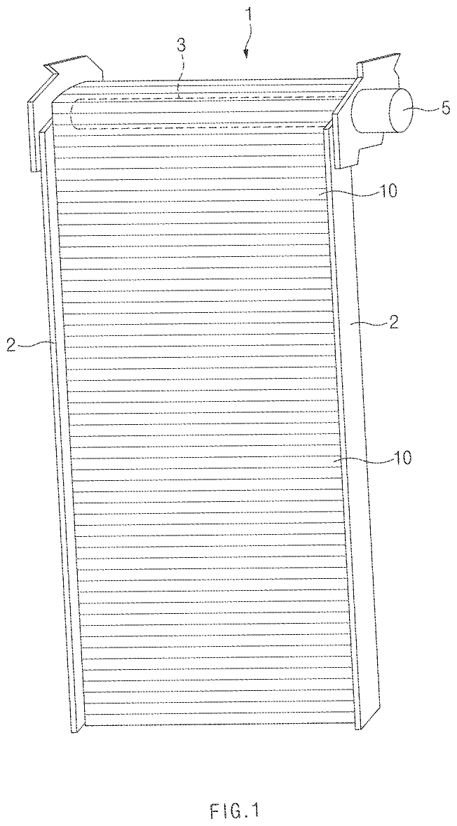

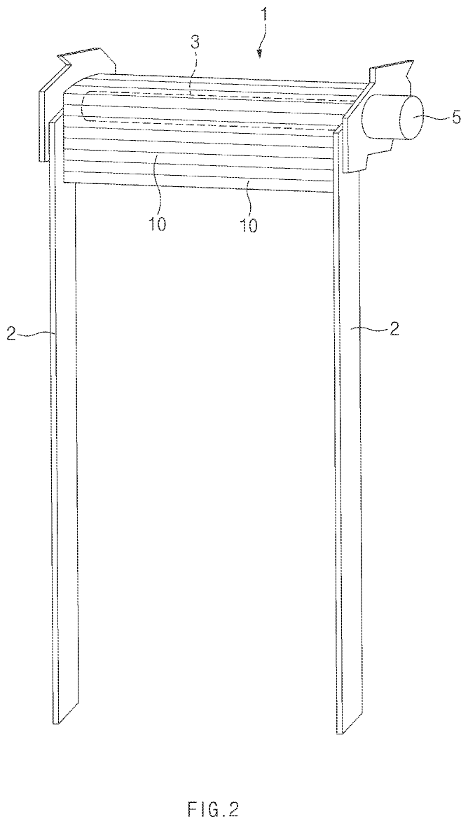

Referring to FIGS. 1 and 2, a roller shutter 1 according to an example embodiment of the present disclosure may include a plurality of slats 10 pivotably hinged together, a drive shaft 3 allowing the slats 10 to be wound or unwound, and a drive motor 5 driving the drive shaft 3. A pair of sidewalls 2 may be positioned on both sides of the plurality of slats 10, and each sidewall 2 may have a guide track guiding the movement of the slats 10. The roller shutter 1 may be mounted in a door opening of a structure such as a cargo van, a trailer, a truck, or a garage, for example.

Referring to FIG. 1, when the plurality of slats 10 are unwound from the drive shaft 3, the plurality of slats 10 may be aligned straightly so that the roller shutter 1 may be closed, and accordingly the roller shutter 1 may separate an interior space of a space or structure from an exterior space. Referring to FIG. 2, when the plurality of slats 10 are wound around the drive shaft 3, the roller shutter 1 may be opened.

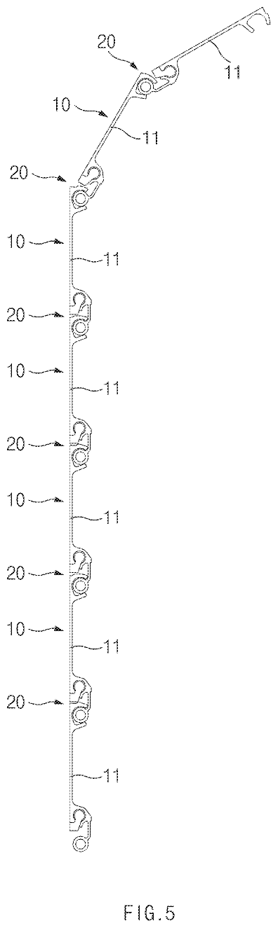

Referring to FIG. 5, a slat connection system according to an example embodiment of the present disclosure may include the plurality of slats 10 continuously arranged through a plurality of hinge mechanisms 20.

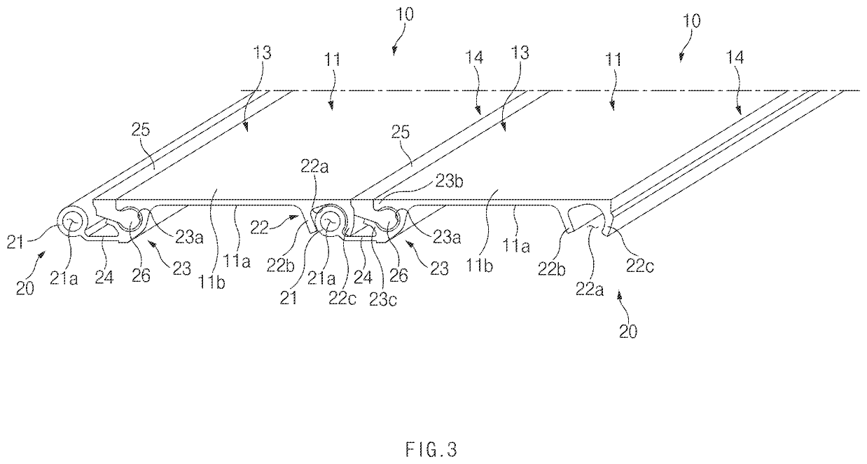

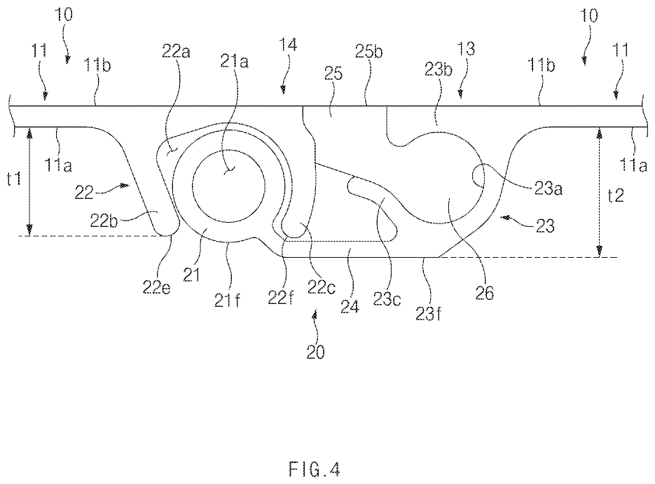

Referring to FIGS. 3 and 4, each slat 10 may include a slat body 11 having a flat plate shape. The slat body 11 may include a first edge 13 and a second edge 14 opposing each other. The slat body 11 may include an inner hinge 21 provided at the first edge 13, and an outer hinge 22 provided at the second edge 14. The slat body 11 may include an interior surface 11a facing the interior space of the structure, and an exterior surface 11b facing the exterior space of the structure.

The inner hinge 21 may have a cylindrical shape with a cavity 21a defined therein. The inner hinge 21 of the slat 10 may protrude from the first edge 13 of the slat body 11 toward the second edge 14 of the slat body 11 of another adjacent slat 10.

The outer hinge 22 may protrude from the interior surface 11a of the slat body 11 toward the interior space of the structure by a selected, designed, preset, or predetermined first thickness t1, and the first thickness t1 of the outer hinge 22 may be greater than the thickness of the slat body 11. The outer hinge 22 may have a hinge groove 22a configured to receive the inner hinge 21. The hinge groove 22a of the outer hinge 22 may be open in a direction perpendicular to a flat surface of the slat body 11. Specifically, the outer hinge 22 may include a first hinge guide 22b and a second hinge guide 22c protruding from the interior surface 11a of the slat body 11 by the first thickness t1. The first hinge guide 22b and the second hinge guide 22c may be spaced apart from each other at the second edge 14 of the slat body 11. The first hinge guide 22b and the second hinge guide 22c may oppose each other, and the first hinge guide 22b and the second hinge guide 22c may be curved to face each other. As an interior edge of the first hinge guide 22b and an interior edge of the second hinge guide 22c are spaced apart from each other, the hinge groove 22a of the outer hinge 22 may be open to the interior space of the structure. The hinge groove 22a may be partially defined by the first hinge guide 22b and the second hinge guide 22c.

Each slat 10 may further include a sealing receiving portion 23 provided at the first edge 13. The sealing receiving portion 23 may protrude from the interior surface 11a of the slat body 11 toward the interior space of the structure by a selected, designed, preset, or predetermined second thickness t2. The second thickness t2 of the sealing receiving portion 23 may be greater than the thickness of the slat body 11. The sealing receiving portion 23 may have a groove 23a. The groove 23a of the sealing receiving portion 23 may be open in a direction parallel (i.e., generally parallel and being parallel at some portion thereof) to the interior surface 11a of the slat body 11 so that it may have a C-shaped cross section. Specifically, the groove 23a of the sealing receiving portion 23 of the slat 10 may have a C-shaped cross section that is open to or toward the inner hinge 21 of the slat 10, and to or toward the second edge 14 and the outer hinge 22 of another adjacent slat 10. The sealing receiving portion 23 may include a first wall 23b formed on and protruding from the interior surface 11a of the slat body 11, and a second wall 23c spaced apart from the first wall 23b. The first wall 23b and the second wall 23c may at least partially define the groove 23a.

According to an example embodiment of the present disclosure, the inner hinge 21 may be connected to, protruding from, or extending from the sealing receiving portion 23 through or via a connection neck 24. A first edge of the connection neck 24 may be integrally connected to the sealing receiving portion 23, and a second edge of the connection neck 24 may be integrally connected to the inner hinge 21. The connection neck 24 may extend from the sealing receiving portion 23 of the slat 10 generally toward the second edge 14 and the outer hinge 22 of another adjacent slat 10, and accordingly the connection neck 24 may connect the sealing receiving portion 23 and the inner hinge 21. The connection neck 24 may extend in a direction parallel to the flat surface of the slat body 11. An interior edge 21f of the inner hinge 21 may be closer to the interior surface 11a of the slat body 11 than part or all of the connection neck 24.

According to an example embodiment of the present disclosure, the first thickness t1 of the outer hinge 22 may be less than the second thickness t2 of the sealing receiving portion 23. The interior edge 21f of the inner hinge 21 may be closer to the interior surface 11a of the slat body 11 than an interior edge 23f of the sealing receiving portion 23. In addition, either or both of an interior edge 22e of the first hinge guide 22b of the outer hinge 22 and an interior edge 22f of the second hinge guide 22c of the outer hinge 22 may be closer to the interior surface 11a of the slat body 11 than the interior edge 23f of the sealing receiving portion 23.

Referring to FIGS. 3 and 4, each hinge mechanism 20 may be configured to pivotably interconnect two adjacent slats 10. The inner hinge 21 of one slat of the two adjacent slats 10 may be pivotably received in the hinge groove 22a of the outer hinge 22 of the other slat of the two adjacent slats 10 to thereby form the hinge mechanism 20.

Referring to FIGS. 3 and 4, each hinge mechanism 20 may include a sealing member 25 interposed between two adjacent slats 10. The sealing member 25 may be interposed between the first edge 13 of one slat 10 and the second edge 14 of the other slat 10. An exterior surface 25b of the sealing member 25 may be aligned (i.e., fully aligned, flush, generally aligned, or substantially aligned; there may be some alignment variation due to a flexible material of the sealing member 25) with the exterior surface 11b of the slat body 11.

Referring to FIGS. 3 and 4, the sealing member 25 may have a cylindrical insert 26, and the insert 26 may protrude from the sealing member 25. The insert 26 may have a solid circular cross-section. The insert 26 of the sealing member 25 may be fitted into and engaged with the groove 23a of the sealing receiving portion 23.

Referring to FIGS. 3 and 4, the inner hinge 21 may be aligned with part or all of the sealing member 25 through the connection neck 24 along a direction parallel to the flat surface of the slat body 11 so that the inner hinge 21 and the sealing member 25 may be each positioned in parallel to the flat surface of the slat 10. Because the interior edge 21f of the inner hinge 21, the interior edge 22e of the first hinge guide 22b of the outer hinge 22, and the interior edge 22f of the second hinge guide 22c of the outer hinge 22 are closer to the interior surface 11a of the slat body 11 than the interior edge 23f of the sealing receiving portion 23, the thickness of the hinge mechanism 20 may correspond to the second thickness t2 of the sealing receiving portion 23. Accordingly, the thickness of the hinge mechanism 20 may be significantly reduced compared to prior designs, and thus the plurality of slats 10 may become slim in a total thickness including the hinge mechanism 20. When the plurality of slats 10 are wound around the drive shaft 3, the winding radius of the plurality of slats 10 may be relatively reduced, and a package of the roller shutter may be relatively simplified.

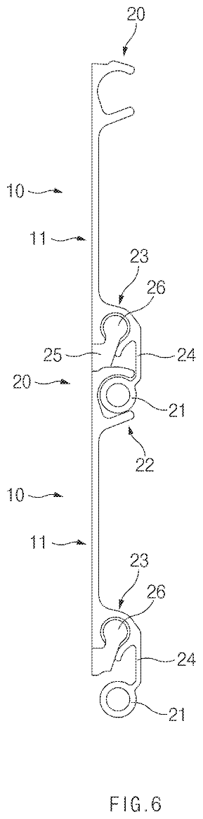

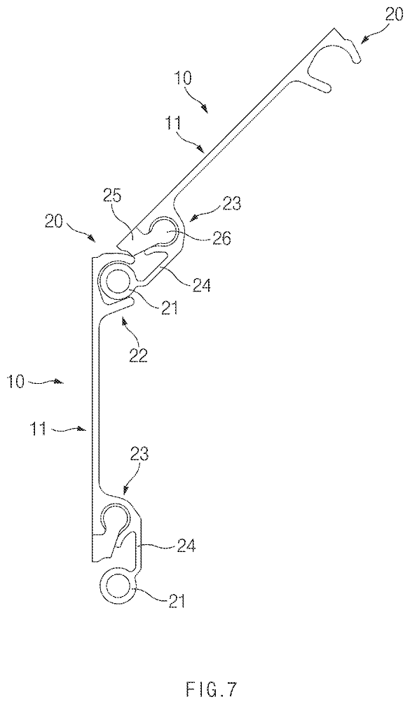

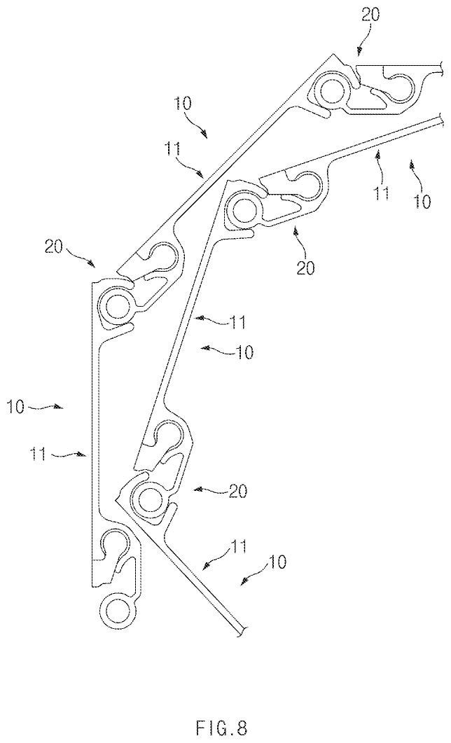

Referring to FIG. 6, when the plurality of slats 10 are aligned vertically, the inner hinge 21 and the sealing member 25 may be aligned vertically (i.e., forming an overall flat or generally flat surface formed by combining the surfaces 11b and 25b). Referring to FIG. 7, as the inner hinge 21 of one slat 10 pivots in the hinge groove 22a of the outer hinge 22 of another adjacent slat 10 at an angle, one slat 10 may be inclined relative to another adjacent slat 10. Referring to FIG. 8, when the plurality of slats 10 are wound around the drive shaft, the hinge mechanism 20 of one slat 10 may be stacked on another slat 10.

As set forth above, a slat connection system according to example embodiments of the present disclosure may be designed to significantly reduce the thickness of the hinge mechanism protruding from the slats, thereby making the plurality of slats slim. Even when the hinge mechanism of one slat is stacked on another slat while the plurality of slats are being wound around the drive shaft, the winding radius of the plurality of slats may be relatively reduced, and the package of the roller shutter may be relatively simplified.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scope of the present disclosure claimed in the following claims.

What is claimed is:

1. A slat connection system for a roller shutter comprising:
a plurality of slats pivotably hinged together,
wherein each slat of the plurality of slats includes a slat body having a first edge and a second edge opposing each other, an inner hinge provided at the first edge, and an outer hinge provided at the second edge,
wherein the inner hinge of a first slat of the plurality of slats is pivotably received in a hinge groove of the outer hinge of a second slat of the plurality of slats with a sealing member interposed between the first and second slats, and
wherein the inner hinge and the sealing member are each positioned in parallel to a flat outer slat surface.

2. The system of claim 1, wherein each slat of the plurality of slats further includes a sealing receiving portion provided at the first edge,
wherein the sealing receiving portion has a sealing member groove, and
wherein the sealing member includes an insert fitted into the sealing member groove of the sealing receiving portion.

3. The system of claim 2, wherein the inner hinge is connected to the sealing receiving portion via a connection neck, and
wherein the connection neck is parallel to the flat outer slat surface.

4. The system of claim 2, wherein the hinge groove is open in a direction perpendicular to the flat outer slat surface.

5. The system of claim 4, wherein the outer hinge includes a first hinge guide and a second hinge guide protruding from an interior slat surface, and
wherein the hinge groove is at least partially defined by the first hinge guide and the second hinge guide.

6. The system of claim 5, wherein the outer hinge protrudes from the interior slat surface by a first thickness,
wherein the sealing receiving portion protrudes from the interior slat surface by a second thickness, and
wherein the first thickness of the outer hinge is less than the second thickness of the sealing receiving portion.

7. The system of claim 6, wherein an inner hinge interior edge of the inner hinge is closer to the interior slat surface than a sealing receiving interior edge of the sealing receiving portion.

8. The system of claim 6, wherein a first hinge guide interior edge of the first hinge guide and a second hinge guide interior edge of the second hinge guide are closer to the interior slat surface than a sealing receiving interior edge of the sealing receiving portion.

9. A slat system comprising:
a first slat having a first slat first end, a first slat second end opposite of the first slat first end with respect to a first direction, a first slat flat outer surface extending along a first plane in the first direction from the first slat second end to the first slate first end, and a first slat interior surface opposite of the first slat flat outer surface;
a first slat sealing receiving portion protruding from the first slat interior surface at the first slat first end;
a first slat connection neck protruding from the first slat sealing receiving portion in the first direction;
a first slat inner hinge protruding from the first slat connection neck in the first direction, the first slat inner hinge having a cylindrical-shaped first slat inner hinge end portion;
a first slat sealing member having a first slat sealing member exterior surface and a first slat sealing member insert;
a second slat having a second slat first end, a second slat second end, the second slat first end being opposite of the second slat second end with respect to a second direction, a second slat flat outer surface extending along a second plane in the second direction from the second slat first end to the second slate second end, and a second slat interior surface opposite of the second slat flat outer surface; and
a second slat outer hinge protruding from second slat interior surface at the second slat second end in a third direction, the third direction being perpendicular to the second plane, the second slat outer hinge having a second slat outer hinge groove opening toward the third direction, wherein the first slat sealing receiving portion having a first slat sealing member groove opening toward the first direction and toward the second slat outer hinge of the second slat, wherein the first slat sealing member insert is fitted in the first slat sealing member groove, such that the first slat sealing member is interposed between the first slat first end and the second slat second end, wherein the cylindrical-shaped first slat inner hinge end portion also protrudes into the second slat outer hinge groove, such that the cylindrical-shaped first slat inner hinge end portion pivotably couples with the second slat outer hinge groove.

10. The system of claim 9, wherein the first slat sealing member has a first slat sealing member exterior surface interposed between the first slat first end and the second slat second end.

11. The system of claim 10, wherein with the slat system in a closed configuration, the first plane is aligned with the second plane, and the first slat sealing member exterior surface is aligned with the first slat flat outer surface and the second slat flat outer surface.

12. The system of claim 9, wherein the first slat sealing member insert and the cylindrical-shaped first slat inner hinge end portion have a majority of their portions aligned along a first geometric line that is parallel with the first plane.

13. The system of claim 9, wherein the first slat sealing member groove and the first slat inner hinge have a majority of their portions aligned along a first geometric line that is parallel with the first plane.

14. The system of claim 9, wherein the first slat sealing member groove, the first slat sealing member insert, the first slat inner hinge, and the cylindrical-shaped first slat inner hinge end portion have a majority of their portions aligned along a first geometric line that is parallel with the first plane.

15. The system of claim 9, wherein with the slat system in a closed configuration, the first plane is aligned with the second plane, and the second slat outer hinge, the first slat sealing member groove, the first slat sealing member insert, the first slat inner hinge, and the cylindrical-shaped first slat inner hinge end portion have a majority of their portions aligned along a first geometric line that is parallel with the first plane.

16. The system of claim 9, wherein the second slat outer hinge protrudes from the second slat interior surface by a first thickness, wherein the first slat sealing receiving portion protrudes from the first slat interior surface by a second thickness, and wherein the first thickness is less than the second thickness.

17. A slat system comprising:
a first slat having a first slat first end, a first slat second end opposite of the first slat first end with respect to a first direction, a first slat flat outer surface extending along a first plane in the first direction from the first slat second end to the first slate first end, and a first slat interior surface opposite of the first slat flat outer surface;
a first slat sealing receiving portion protruding from the first slat interior surface at the first slat first end;
a first slat connection neck protruding from the first slat sealing receiving portion in the first direction;
a first slat inner hinge protruding from the first slat connection neck in the first direction, the first slat inner hinge having a cylindrical-shaped first slat inner hinge end portion;
a first slat sealing member having a first slat sealing member exterior surface and a first slat sealing member insert;
a second slat having a second slat first end, a second slat second end, the second slat first end being opposite of the second slat second end with respect to a second direction, a second slat flat outer surface extending along a second plane in the second direction from the second slat first end to the second slate second end, and a second slat interior surface opposite of the second slat flat outer surface; and
a second slat outer hinge protruding from second slat interior surface at the second slat second end in a third direction, the third direction being perpendicular to the second plane, the second slat outer hinge having a second slat outer hinge groove opening toward the third direction, wherein the first slat sealing receiving portion having a first slat sealing member groove opening toward the first direction and toward the second slat outer hinge of the second slat, wherein the first slat sealing member insert is fitted in the first slat sealing member groove, such that the first slat sealing member is interposed between the first slat first end and the second slat second end, wherein the cylindrical-shaped first slat inner hinge end portion also protrudes into the second slat outer hinge groove, such that the cylindrical-shaped first slat inner hinge end portion pivotably couples with the second slat outer hinge groove, wherein the second slat outer hinge protrudes from the second slat interior surface by a first thickness, wherein the first slat sealing receiving portion protrudes from the first slat interior surface by a second thickness, and wherein the first thickness is less than the second thickness.

18. The system of claim 17, wherein the first slat sealing member insert and the cylindrical-shaped first slat inner hinge end portion have a majority of their portions aligned along a first geometric line that is parallel with the first plane.

19. The system of claim 17, wherein the first slat sealing member groove and the first slat inner hinge have a majority of their portions aligned along a first geometric line that is parallel with the first plane.

20. The system of claim 17, wherein the first slat sealing member groove, the first slat sealing member insert, the first slat inner hinge, and the cylindrical-shaped first slat inner hinge end portion have a majority of their portions aligned along a first geometric line that is parallel with the first plane.
